(19) United States
(12) Patent Application Publication
(10) Pub. No.: US 2008/0137042 A1
(43) Pub. Date: Jun. 12, 2008

(54) Beam shaping method and apparatus

(75) Inventor: Ilkka A. Alasaarela, Liminka (FI)

Correspondence Address: HARRINGTON & SMITH, PC, 4 RESEARCH DRIVE, SHELTON, CT, 06484-6212, US

(73) Assignee: Upstream Engineering Oy

(21) Appl. No.: 11/998,783

(22) Filed: Nov. 30, 2007

Related U.S. Application Data
(60) Provisional application No. 60/872,051, filed on Nov. 30, 2006.

(51) Int. Cl. G03B 21/14

(52) U.S. Cl. 353/102

(57) ABSTRACT

An optical device includes a source such as an LED, a microdisplay such as an LCoS panel, and one or more cylindrical lens surfaces that (in combination if more than one) changes the aspect ratio of light emanating from the source to the aspect ratio of the microdisplay without clipping. The cylindrical optical surface defines parallel cross sections, each of which define a center of curvature such that the centers of curvatures together define a line that crosses an optical axis between the microdisplay and the source, or an extension or that axis. Changing the aspect ratio in this manner preserves total luminance since clipping is not used to change the aspect ratio, and provides a substantially uniform illumination across the new aspect ratio. Also detailed is a method and further details of an exemplary pocket sized optical engine for which the output of the microdisplay is directed to a projection lens.

### CROSS REFERENCE TO RELATED APPLICATIONS

This application claims priority to U.S. Provisional Application Ser. No. 60/872,051, filed on Nov. 30, 2006 and entitled “Beam Shaping Method”, the contents of which are incorporated by reference herein in its entirety. These teachings are also related to co-owned U.S. Provisional Application Ser. No. 60/861,793 (filed on Nov. 30, 2006), U.S. patent application Ser. No. 11/891,362 (filed on Aug. 10, 2007), and issued U.S. Pat. Nos. 7,059,728 and 7,270,428, the contents of which are all incorporated by reference herein in their entirety.

### TECHNICAL FIELD

These teaching generally relate to data projectors, specifically to light emitting diode (LED) illuminated data projectors and their optical engines and lens arrangements.

### BACKGROUND

In past years advances in high-brightness light emitting diodes (LEDs) have opened the way to new kinds of applications. LEDs have become used as flashes in cellular phones and in other digital cameras, as back lighting in large liquid crystal display LCD screens, and as light sources in rear projection television RPTV displays. One of the new applications these LEDs will enable is a very small mobile data projector, such as a handheld one that will fit nicely in one's pocket. LEDs have several desirable properties for that application, such as small size, cheap price, instant-on feature, colour richness, safety, and by recent advances their brightness too. These kinds of projectors are not yet on the market though many companies have presented their desire to use them in consumer products. One challenge for getting that kind of application to the market is to design and build the optical engine so well that the brightness and image quality of the projector would satisfy the anticipated market demand. Still new innovations are needed for utilizing the properties of the LED chip as well as possible for achieving the desired performance.

So one of the key problems that these teachings address is to achieve sufficient performance from the above mentioned LED-based real pocket projectors, i.e. good brightness and uniformity, low power consumption, small size and small prize.

High brightness LED chips typically are rectangular in their geometry. LED chips emit light to substantially a hemisphere. The light needs to be collected from that hemisphere and shaped to form a rectangular beam to the micro-display. Micro-displays are for example liquid crystal devices (LCD), liquid crystal on silicon devices (LCoS) or digital micro-mirror devices (DMD). Relevant teachings in this regard may be seen as co-owned U.S. Pat. Nos. 7,059,728 and 7,270,428, referenced above.

In larger conventional projectors, which typically use an arc-lamp as a light source, the collection and beam shaping is typically done by using an elliptical mirror together with a lens-lightpipe-lens system or a fly's eye lens array. The elliptical reflector collects the light and the lightpipe or the fly's eye lens array shapes the beam to match with the rectangular micro-display. Elliptical reflectors are not seen as viable for use with high brightness LEDs, because LEDs demand mounting to a substrate, which in its part needs to be integrated with a heat sink. Alternatives for the elliptical reflectors for light collection from LED chips are for example lenses, total-internal-reflection (TIR) collimators or truncated parabolic reflectors. These components collect light but do not shape the beam well enough to match the micro-display shape. These components can be used together with the lightpipe or the fly's eye lens array in order to get rectangular illumination of a desired aspect ratio.

One important issue in LED projector design is the etendue law, also detailed in the above referenced U.S. patents. Brightness of the high brightness LEDs is still quite weak for projection applications in the prior art. Therefore, optical systems need to use as large a chip as possible to illuminate the micro-display in the limits of the etendue law. On the other hand, the micro-display needs to be small (below 0.8″ and preferably below 0.55″ diagonal) in order to have the projector attain a sufficiently small size (handheld or even pocket size). In order to have highest possible brightness, the etendue of the LED chip should be equal to the etendue of the micro-display. In that case, the optical engine disposed prior to the microdisplay should not increase the system etendue, in order to be able to couple as much light as possible from the LED chip to the micro-display.

Now, in the view of the etendue law, a drawback of using a lightpipe or fly's eye lens array is that the etendue of the optical system is increased prior to the micro-display, which will result either in an increase in the size of the projector, or a loss of brightness. Although etendue is preserved in the lightpipe and fly's eye lens components themselves, the system etendue is increased following these components.

Another way to shape the beam to the desired rectangular form is to benefit from the fact that the LED chip has a rectangular geometry. A typical high-brightness LED chip is thin and square-shaped, with dimensions of 1 mm×1 mm×0.1 mm for example. There are two kinds of LED chips available: ones in which the chip is encapsulated with an optically transparent material, and ones without such encapsulation. The non-encapsulated chips can be imaged by using a pair of lenses to form a rectangular illumination to a micro-display. Encapsulated chips can be “imaged” by using for example components described in the above-referenced co-owned U.S. patent application Ser. No. 11/891,362 entitled “Illuminator Method and Device”.

One drawback of these approaches is that if the LED chip is square, also the illumination is square. Because cylindrically symmetric beam shaping optics is used, the shape of the illumination will resemble the shape of the source even at its best. The better the etendue and efficiency are preserved, the more the illumination has the shape of the LED chip. So, the drawback is that the aspect ratio of the rectangular illumination, i.e. the ratio of the width and the height of the rectangular illumination, is limited to be approximately the same as the aspect ratio of the source. When using a typical LED chip as a light source, which as above is dimensioned as 1 mm×1 mm×0.1 mm, the beam output would have aspect ratio of 1:1, i.e. square. However, the desired aspect ratios of the image on the micro-display (and on the resulting projected image) are typically different from that 1:1 (square) aspect ratio; such as 4:3 in most cases and 16:9 in another popular case just to mention two. That mismatch between the illumination and the micro-display aspect ratios results in only a portion of the beam being used for the illumination. For example if a 4:3 rectangular micro-display is illuminated with a beam with a 1:1 aspect ratio, approximately 25% of the light will be lost. Of course the situation is typically not this straightforward because the illuminating beam typically has edges and corners that are not well defined (not very sharp) but rather the beam resembles a rectangular aspect ratio instead of being precise rectangular. However, even though the geometries are not precise, the mismatch causes a loss of brightness and/or weakens the uniformity of the illumination.

One problem these teachings address is how to change the aspect ratio of a beam with rectangular illumination while sufficiently preserving brightness and/or uniformity of illumination.

### SUMMARY

In accordance with an embodiment of the invention is a projection arrangement that includes at least one microdisplay, at least one light source, and at least one cylindrical optical surface arranged between the at least one light source and the at least one microdisplay, of which the cylindrical optical surface changes the aspect ratio of the illumination to match to the shape of the microdisplay.

In accordance with another embodiment of the invention is an apparatus that includes illumination means that comprises a first aspect ratio, display means that comprise a second aspect ratio, and lens means disposed between the display means and the illumination means. The lens means has an arcuate surface that is shaped for changing an aspect ratio of illumination emanating from the illumination means from the first aspect ratio to the second aspect ratio without clipping the emanating illumination. IN a particular embodiment, the illumination means is a LED chip, the display means is a microdisplay, and the lens means is one or more cylindrical optical surfaces.

In accordance with another embodiment of the invention is a method for manipulating light. In this method, light is emanated from a source having a first aspect ratio, the emanated light is passed through at least one cylindrical optical surface that is shaped to change the emanated light from the first aspect ratio to a second aspect ratio without clipping the emanated light, and thereafter the emanated light is directed to a microdisplay surface having the second aspect ratio.

### BRIEF DESCRIPTION OF THE DRAWINGS

These teachings are made more evident with reference to the drawings figures noted below. Further objects and advantages in addition to those noted above will become apparent from a consideration of the ensuing description and drawings.

FIG. 1 is a schematic diagram of an illumination system without the beam shaping teachings of this invention, made by using Zemax optical modelling software.

FIG. 2 is to scale, and is an intensity plot of (square) illumination at the microdisplay resulting from the system of FIG. 1 using a square LED source.

FIG. 3 is similar to FIG. 1 but with a cylindrical lens disposed approximately half way between the first lens and the micro-display according to an embodiment of the invention.

FIG. 4 is to scale, and is an intensity plot of (non-square) illumination at the microdisplay resulting from the system of FIG. 3 using a square LED source.

FIG. 5A-5D various views and sections of a cylindrical lens according to an embodiment of the invention.

FIG. 6 is a schematic diagram of an optical engine of a LED-projector made with field-sequential LCD panel micro-display and a cylindrical lens disposed approximately halfway between the relay lens and the micro-display according to a specific embodiment of the invention.

FIG. 7A is a ray tracing diagram for a telecentric illumination arrangement without a cylindrical lens according to these teachings, and FIG. 7B is an intensity plot of (square) illumination at the microdisplay resulting from FIG. 7A and a square LED source.

FIGS. 8A and 8B are different views of the same telecentric illumination arrangement as FIG. 7A but with added cylindrical lens surfaces according to an embodiment of the invention, and FIG. 8C is an intensity plot of (non-square) illumination at the microdisplay resulting from FIGS. 8A and 8B and a square LED source.

FIGS. 9A and 9B are similar to FIGS. 7A and 7B respectively but for a non-telecentric illumination arrangement.

FIGS. 10A and 10B are similar to FIGS. 8A and 8B but for a non-telecentric illumination arrangement, and FIG. 10C is similar to FIG. 8C resulting from FIGS. 10A and 10B and a square LED source.

### DETAILED DESCRIPTION

One purpose of the invention is to provide method how the aspect ratio of the illuminating beam can be modified to match with the micro-display shape avoiding the loss of brightness and degreased uniformity.

Accordingly, several object and advantages of embodiments of the invention are:

good efficiency

good uniformity

etendue preservation

small and slim form factor

cheap mass-manufacturing

versatility to convert between different aspect ratios.

The background section above detailed problems with a lightpipe-flys eye lens arrangement in that system etendue is increased. The inventor has determined that such an increase of the system etendue will not occur if the beam already exhibits a rectangular spatial distribution of the desired aspect ratio when entering into the lightpipe, or if the beam has already a rectangular angular distribution pattern of the desired aspect ratio when entering to the fly's eye lens array. However, if that would be the case, those components would not be needed at all, and we should have some other means to form the rectangular beam before these components. As such, embodiments of this invention provide an optical engine without a lightpipe and/or flys eye lens arrangement, though other embodiments do not exclude either of those components. Following are described some embodiments of the invention with reference to the figures.

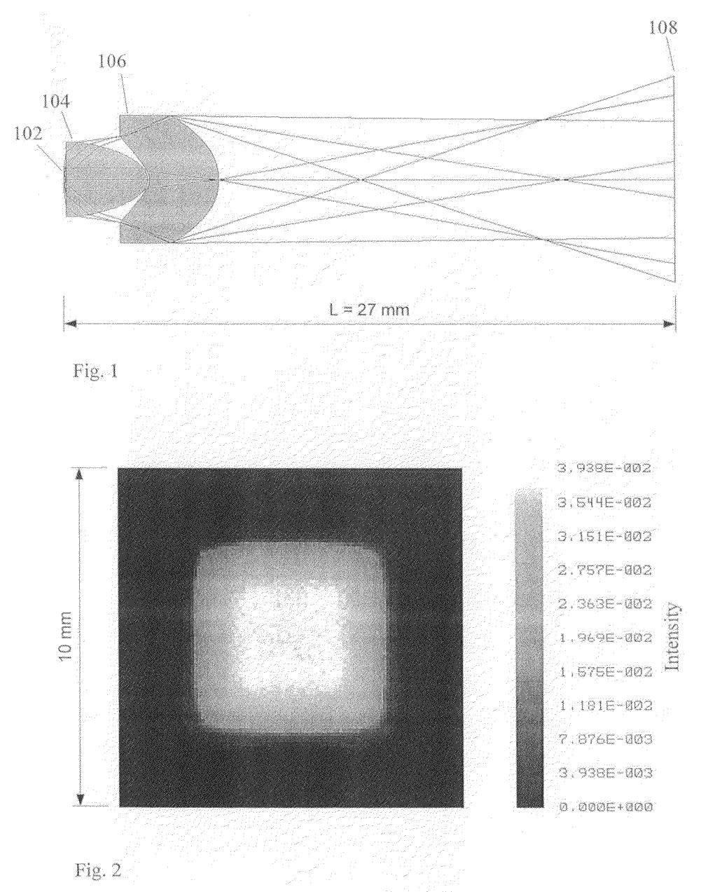

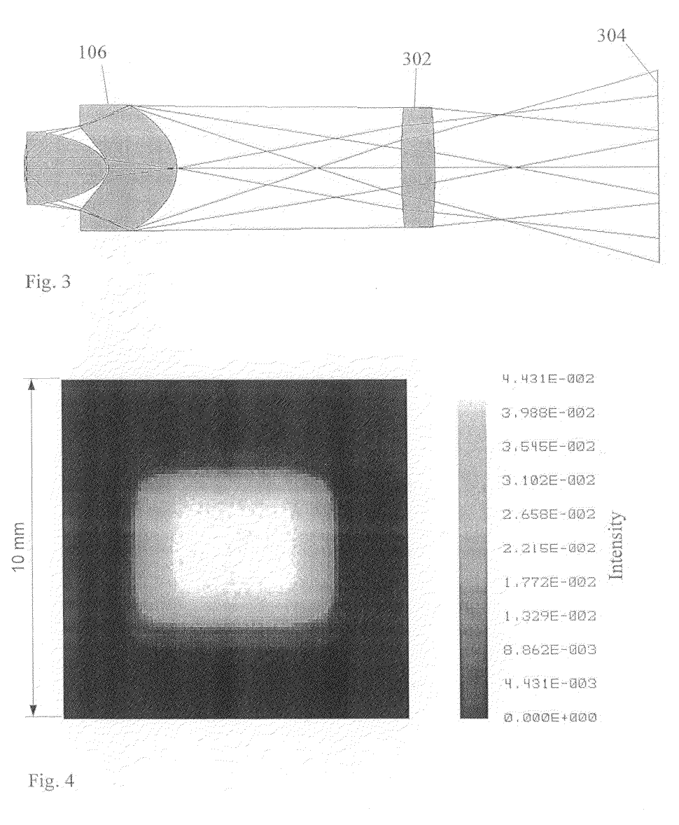

FIG. 1 shows an exemplary illumination system without the beam shaping method or apparatus of the invention. The figure is made by using Zemax optical modelling software (by ZEMAX Development Corporation, Bellevue, Wash., USA), which is a feasible tool for modelling many kind of optical systems. The light source (102) shown is a thin square shaped LED chip. Two lenses (104,106) collect the light and form a smoothed image (108) of the LED chip at distance L from the LED chip. FIG. 2 is to scale and shows the illumination at distance L. As seen in FIG. 2, a square shaped LED chip forms a square shaped illumination. 96% of the light emitted from the LED chip is illuminating the square. Even though the edges are not perfectly sharp and the illumination is dimmer near the edges, that edge illumination could be used to illuminate a square shaped micro-display for example. However, the problem is that if the micro-display has a 4:3 aspect ratio, approximately 25% of the light would be lost. The 4:3 aspect ratio would have to be clipped from the existing square illumination shown, resulting in the illumination that is outside that 4:3 rectangle but within the square illumination shown in FIG. 2 to be lost.

### Problem Solving by the Cylindrical Lens Method and Apparatus

FIG. 3 shows how the above mentioned problem can be solved by inserting a cylindrical lens (302) approximately half way between the lens (106) and the micro-display (304). The cylindrical lens shapes the beam to the desired 4:3 aspect ratio as shown in FIG. 4, which is to scale. The illumination efficiency is 88% and so the 25% loss of light that would occur from clipping a 4:3 aspect ratio from the illumination seen in FIG. 2 is substantially reduced. The cylindrical lens modifies only one dimension of the beam.

### Description of the Cylindrical Lens

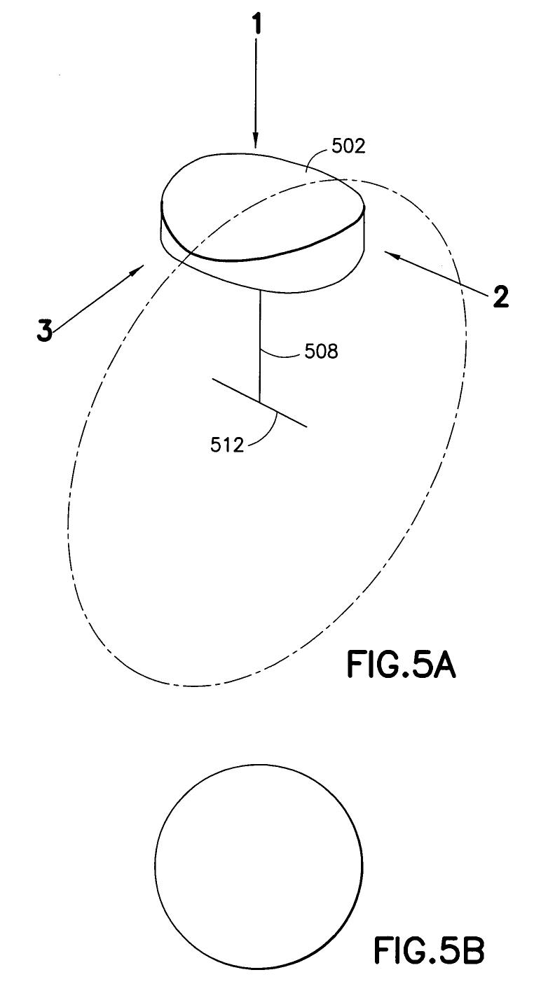

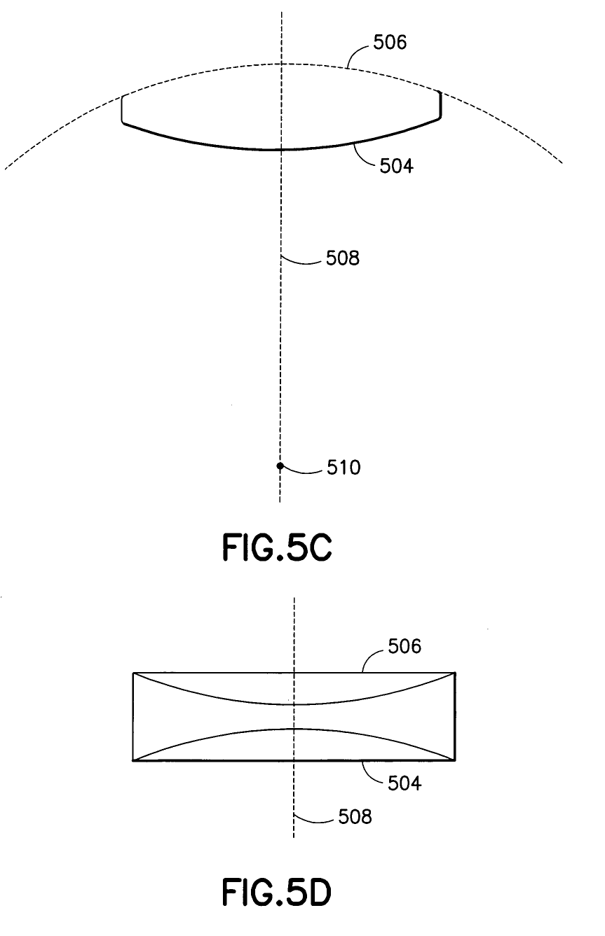

FIGS. 5A-5D show the cylindrical lens according to an embodiment of the invention. The term cylindrical lens is used to define a lens having at least one surface that is curved as detailed herein. FIG. 5A shows a 3D-view of the lens. FIG. 5B shows view from top of the lens, as shown by the arrow with number one in FIG. 5A. FIGS. 5C and 5D show views from front and right side of the lens as shown by the arrows with respective numbers two and three in FIG. 5A. The cylindrical lens is made of a solid block of material (502) which is optically transparent in the desired wavelength range. Both the input surface (504) and output surface (506) of the cylindrical lens have a cylindrical shape, whose center of curvatures are located at the system optical axis (508) from the LED chip to the center of the micro-display. The aspect ratio of the illumination changes with shorter focal length of the cylindrical lens.

The arcuate surface(s) of the lens are termed cylindrical surfaces 504, 506, and may be conceptualized in simplest form as planar surfaces with a curvature imposed along a single dimension. The term cylindrical surface is used to denote that the surface is like a portion of a cylinder's arcuate surface, whether the cylinder has a circular or ellipsoidal cross section. Unlike traditional focusing lenses, there is no single point defining the center of curvature for a cylindrical surface; each cross section of that cylindrical surface defines a center of curvature (point) for that cross section, and the points from those various cross sections form a single line. FIG. 5D shows one such cross section, with the center of curvature along the line of the optical axis 508 at the apex of the curvatures for the input and output surfaces 504, 506. The line defined by several such points would span the view of FIG. 5C from side to side, and is shown in dashed line 512 at FIG. 5A. Such a line for FIG. 5D is perpendicular to the drawing sheet. It is noted that the line formed by the centers of curvature need not cross that portion of the system optical axis that lies physically between the source and the display surface of the microdisplay, but may in fact cross the optical axis as extended beyond the physical bounds of those components. This will most likely be the case for embodiments that are pocket sized projectors. Note that the net effect of the cylindrical surface is to elongate (or shrink, depending on which direction the light travels) the aspect ratio in only one direction. Where the plane of the microdisplay active area is considered the x-y plane, the cylindrical surface operates to magnify light from the source in one of the x and y directions more than it magnifies the light in the other of the x and y directions.

Further complexity may be added by imposing several cylindrical curvatures along a single surface, such that the lines defined by the cross sectional center of curvatures of the different cylindrical curvatures does not intersect across the surface. Preferably, such lines would be parallel.

### Designing the System

By applying this innovative idea of using a cylindrical lens as described here, an experienced optical designer can find a suitable shape and position for the cylindrical lens for solving his specific illumination problem by using one of the sophisticated optical modelling tools such as Zemax, Oslo, Code V etc. The radius of curvature of the input surface and the output surface can be varied: they can be convex or concave depending on the specific optical system needs. The radius of curvature can be even infinity for either of the two surfaces (e.g., one may be a planar surface). The input and the output surfaces can be aspheric as well.

### Three Channels LCD Engine

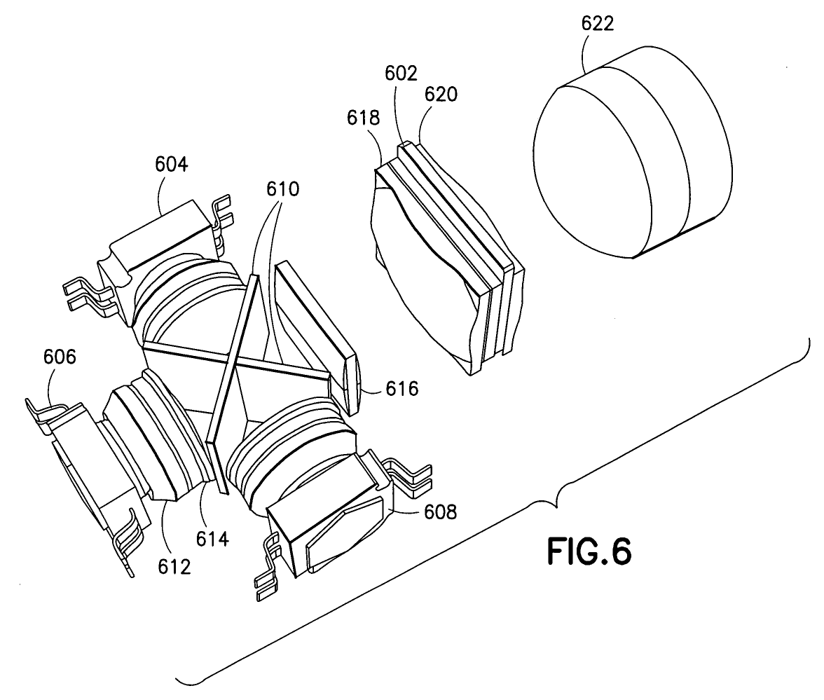

FIG. 6 shows another example of the apparatus and a use of the method. The figure shows an optical engine of a LED-projector made with field-sequential LCD panel micro-display (602). The panel is illuminated by using three LEDs: red (604), green (606) and blue (608), forming three illumination channels. The beams from these channels are combined before the panel by using crossed dichroic mirrors (610). Each channel contains a LED package containing a LED chip of one color, a beam shaping unit (612), such as shown in U.S. patent application Ser. No. 11/891,362 (referenced and incorporated above), and a relay lens (614). Generically, the beam shaping unit may be considered a collection and beam shaping optical device since it collects light from multiple (three) different sources 604, 606, 608. The beam out of the beam shaping unit is substantially telecentric, and the relay lens 614 turns the beams to coincide at the micro-display 602. Approximately half way (optically) between the relay lens 614 and the micro-display 602 there is a cylindrical lens (616). Without the cylindrical lens 616, the illumination at the micro-display 602 would be square (assuming square LEDs), but the cylindrical lens 616 changes the aspect ratio to be 4:3 matching the shape of the micro-display 602. There is a lens (618) before the LCD panel microdisplay 602, which turns the illumination to telecentric before the panel in order to achieve maximum contrast. A field lens (620) after the LCD panel 602 turns the ray cones towards the entrance aperture of the projection lens (622), which images the image from the panel 602 to the projection screen that is viewed by the user. See co-owned U.S. provisional patent application 60/861,793 (filed on Nov. 30, 2006 and referenced and incorporated above) entitled “Beam Shaping Component and Method” for further details as to the telecentric transform.

### EXAMPLE 1

### A Telecentric Illumination Engine with Cylindrical Lenses

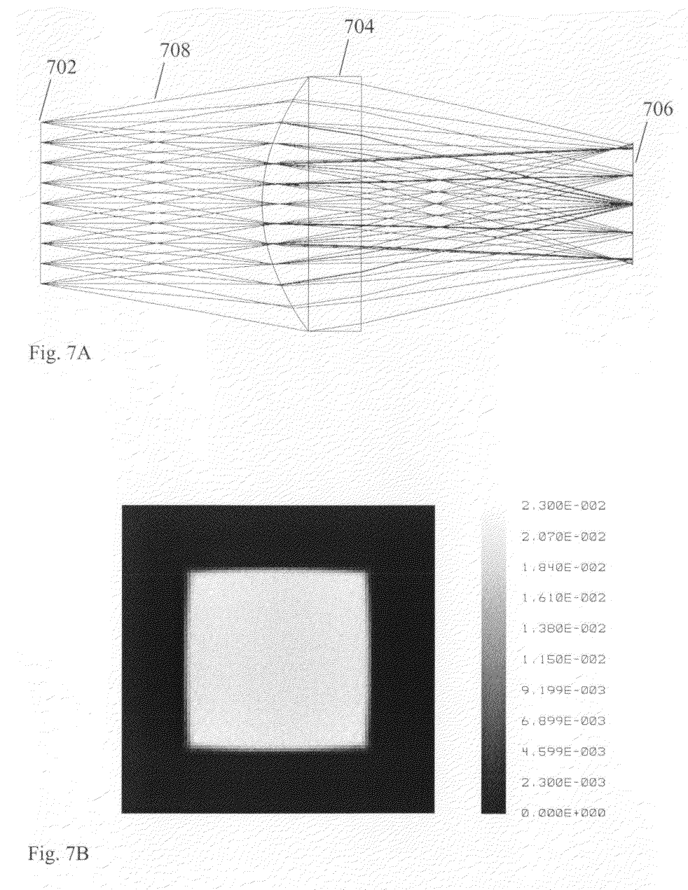

FIG. 7A shows a telecentric illumination arrangement for projection purposes without a cylindrical lens. Plane (702) is an illuminating plane, having light output with square-shaped angular distribution such as from a square LED source. The angular distribution for each point at the illuminating plane 702 is uniform in the x and y dimensions (perpendicular to the drawing), with 10 degree half angle for both directions. That can be for example the light output from a fly's eye lens, from a lightpipe arrangement, or from a high-NA lens. A plano-convex relay lens (704) focuses the illumination beam to form rectangular illumination to the microdisplay (706). Rays (708) show the raypaths from the illuminating plane 702 to the microdisplay 706. FIG. 7B shows the rectangular illumination at the microdisplay 706. As we can see, the shape of the illumination at the microdisplay 706 is square, because of the square shaped angular distribution at the illuminating plane 702. That is the situation without cylindrical lenses.

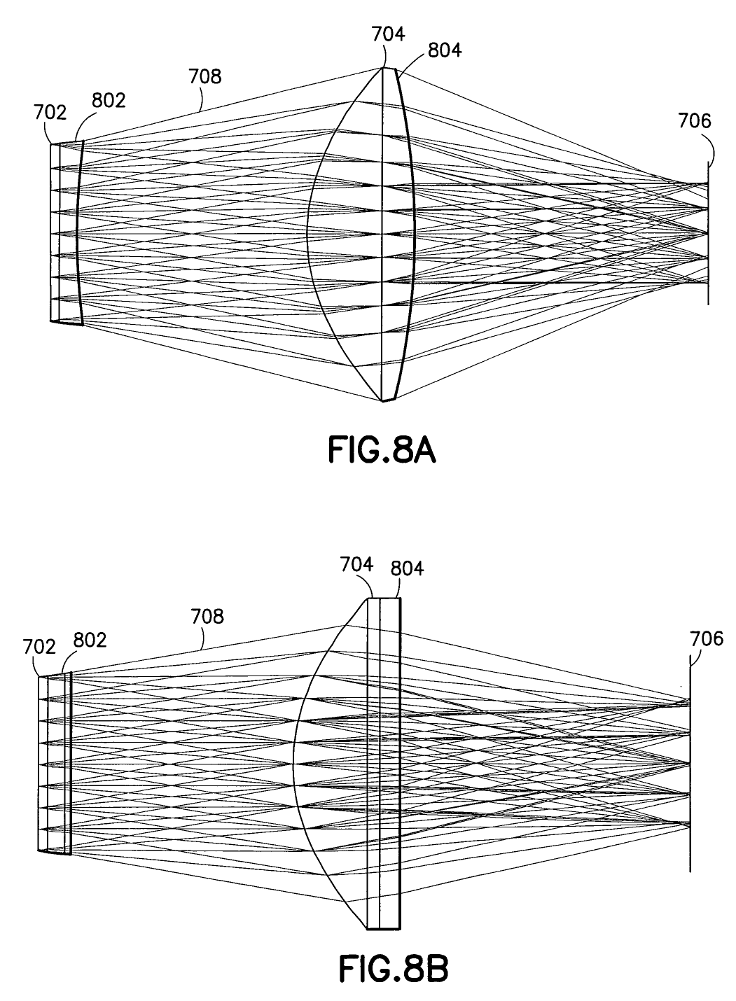

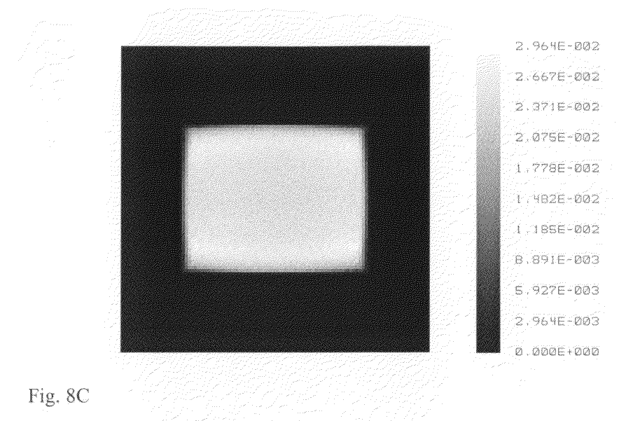

FIGS. 8A and 8B show the same telecentric illumination arrangement as presented in FIG. 7A, but now with added cylindrical surfaces. FIG. 8A shows an yz-view of the arrangement and FIG. 8B shows an xz-view, so FIGS. 8A and 8B are transverse views of the same system. A cylindrical lens (802) has been inserted just after the illuminating plane (702). In addition to that, the planar surface of the plano-convex lens (704) has been changed to a cylindrical surface (804). FIG. 8C shows the rectangular illumination at the microdisplay 706, which is not square anymore but a rectangle with approximately 4:3 aspect ratio.

### EXAMPLE 2

### A Non-Telecentric Illumination Engine with Cylindrical Lenses

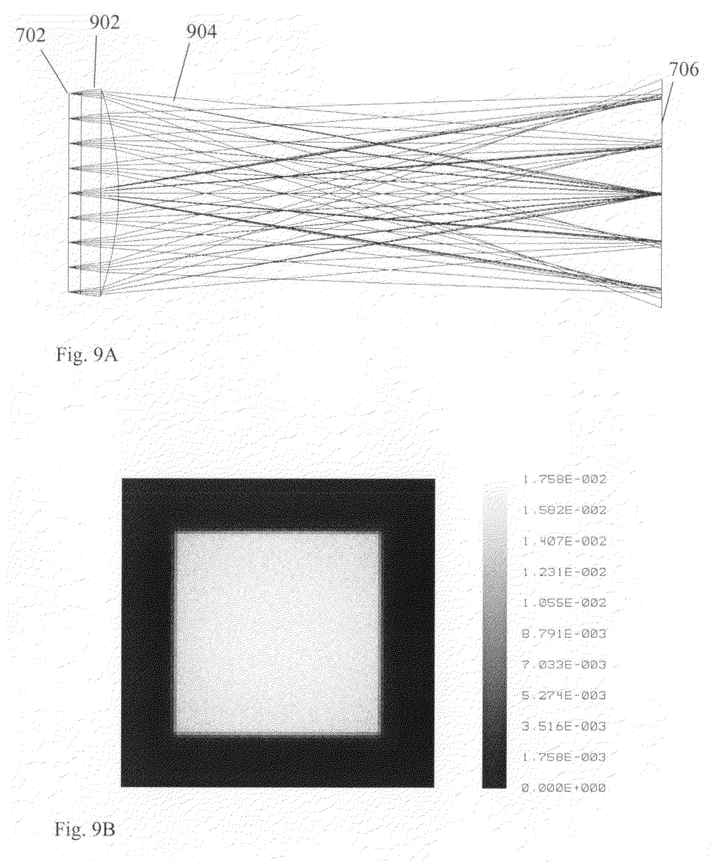

FIG. 9A shows a non-telecentric illumination arrangement for projection purposes without a cylindrical lens. Plane (702) is an illuminating plane, having light output with square-shaped angular distribution. A plano-convex relay lens (902) focuses the illumination beam to form rectangular illumination to the microdisplay (706). Rays (904) show the raypaths from the illuminating plane 702 to the microdisplay 706. FIG. 9B shows the rectangular illumination at the microdisplay 706. The shape of the illumination at the microdisplay 706 is the same as the shape of the angular distribution at the illuminating plane 702, i.e. square. That is the situation without cylindrical lenses.

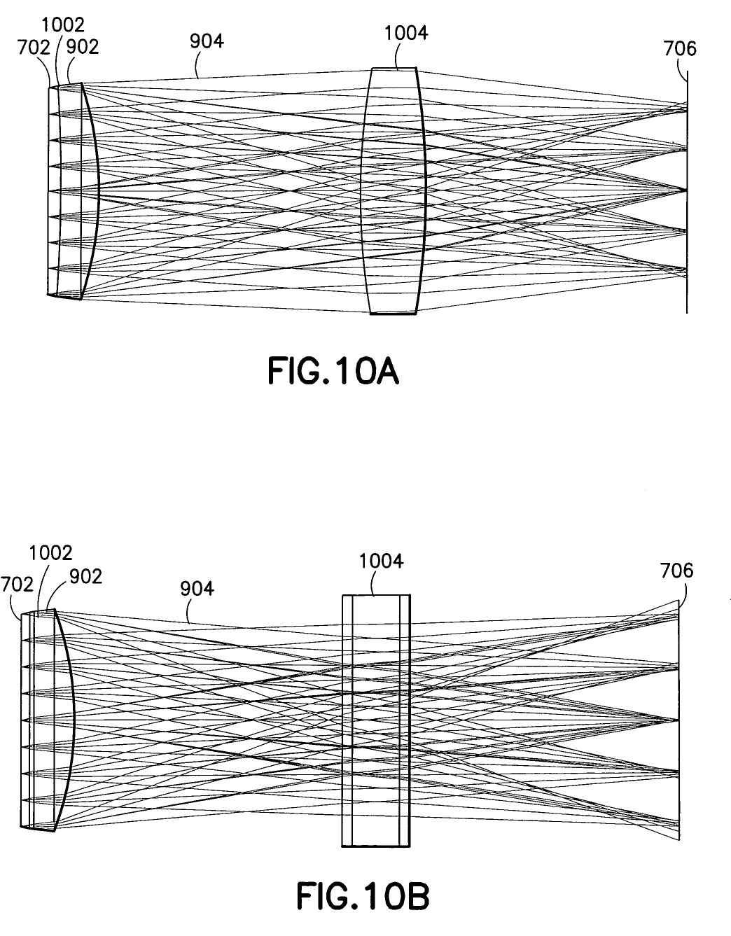

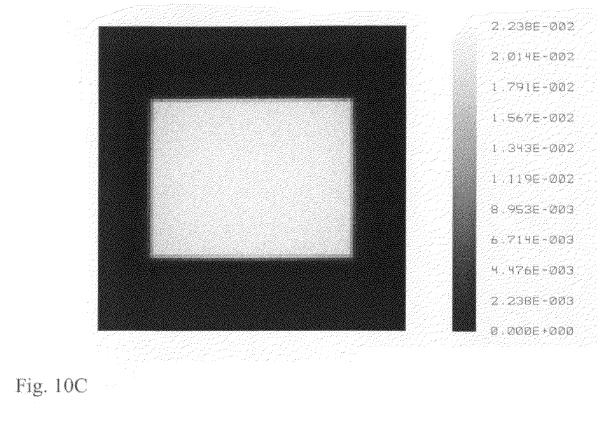

FIGS. 10A and 10B show the same non-telecentric illumination arrangement as presented in FIG. 9A, but now with added cylindrical surfaces. FIG. 10A shows an yz-view of the arrangement and FIG. 10B shows an xz-view. The planar surface of the plano-convex relay lens (902) has been changed to a cylindrical surface (1002), and a cylindrical lens (1004) has been inserted between the relay lens (902) and the microdisplay (706). FIG. 10C shows the rectangular illumination at the microdisplay 706, which is not square anymore but a rectangle with approximately 4:3 aspect ratio.

### CONCLUSION, RAMIFICATIONS, AND SCOPE

Accordingly the reader will see that, according to embodiments of the invention is a method and apparatus for changing the aspect ratio of a rectangular beam by using a cylindrical lens. While the above description contains many specifics in order to illustrate by example these teachings, these should not be construed as limitations on the scope of the invention, but as exemplifications of the presently preferred embodiments thereof. Many other ramifications and variations are possible within the teachings of the invention. For example by adjusting the shape and the position of the cylindrical lens, it can be used to illuminate 16:9 or some other aspect ratio micro-display by using rectangular source chip or chips. The source can be non-square, too. For example, if the LED chip has 3:2 aspect ratio, one can use the cylindrical lens to modify that aspect ratio to 4:3 of 16:9. In addition to that, two or more LED chips can be used for example such that two square shaped LED chips are mounted next to each other to form a source with a 2:1 aspect ratio. Then a cylindrical lens can fine tune the beam to match micro-displays with a 16:9 aspect ratio. A cylindrical lens can also modify beams which have been shaped rectangular already by using a lightpipe or fly's eye lens array if desired in some applications. Generally speaking, the beam shaping method and apparatus of the invention can be used in wide variety of applications where aspect ratio of rectangular illumination needs to be changed for some reason.

A cylindrical lens can also be formed by using several lenses instead of one integrated lens, although one component normally gives the highest efficiency. Cylindrical lenses can also contain other support or aligning structures as known in the art of optomechanical design which are not specifically shown in the schematic figures above. Although the figures above show embodiments of the cylindrical lens where it has circular cross section perpendicular to the optical axis (see FIG. 5B), the cross section could as well have other geometrical shape such as elliptical or rectangular. Typically the shape of the cross section is chosen so that the clear aperture of the component allows the whole beam to pass the component. Preferably the input and output surfaces of the cylindrical lens are antireflection coated for maximized optical transmission. The cylindrical lens can be made from optical plastic or glass materials for example by tooling, grinding or preferably by moulding.

A LCD was used as an exemplary micro-display in the examples above. The cylindrical lens and the method of using it according to the invention can also be employed with LCoS, digital micromirror device DMD, or some other micro-display and their corresponding optical engine configurations.

I claim:

1. A projection arrangement comprising:
at least one microdisplay;
at least one light source; and
at least one cylindrical optical surface arranged between the at least one light source and the at least one microdisplay, which cylindrical optical surface changes the aspect ratio of the illumination to match to the shape of the microdisplay.

2. The projection arrangement of claim 1, wherein the at least one microdisplay comprises at least one of a liquid crystal LCD microdisplay, a liquid crystal on silicon LCoS microdisplay, a micro-electro mechanical modulator MEMS microdisplay, and digital micromirror device DMD microdisplay.

3. The projection arrangement of claim 1, wherein the at least one light source comprises at least one of light emitting diode LED, a laser diode, and an organic light emitting diode OLED.

4. The projection arrangement of claim 1, which is part of a data projector, a rear projection television, a rear projection screen, a head-up display and a medical imaging device.

5. The projection arrangement of claim 1, wherein the light source is substantially imaged to the microdisplay, and wherein cylindrical optical surface is arranged so as to change the magnification of the imaging differently in two different perpendicular directions across a face of the microdisplay.

6. The projection arrangement of claim 1, wherein the at least one light source has a substantially square emitting area and the at least one microdisplay comprises a substantially rectangular active area that is not square.

7. The projection arrangement of claim 6, wherein the emitting area measures 0.8 inches or less along its diagonal.

8. The projection arrangement of claim 1, further comprising at least one collection and beam shaping optical device between the at least one light source and the at least one micro-display, which collection and beam shaping optical device collects light from the light source and forms an angular substantially rectangular output beam with an aspect ratio different from an aspect ratio of an active area of the rectangular micro-display.

9. The projection arrangement of claim 8, wherein the at least one collection and beam shaping optical device comprises at least one of a fly's eye lens array, a lightpipe, an imaging lens, and a high-numerical aperture lens.

10. The projection arrangement of claim 1, wherein the cylindrical optical surface defines parallel cross sections, each of which define a center of curvature such that the centers of curvatures together define a line that crosses an optical axis between the microdisplay and the light source or an extension of that optical axis.

11. The projection arrangement of claim 10, wherein the said cylindrical optical surface comprises a first cylindrical optical surface and the said line comprises a first line; the projection arrangement further comprising a second cylindrical optical surface that defines parallel cross sections, each of which define a center of curvature such that the centers of curvatures together define a second line that is parallel with the first line.

12. The projection arrangement of claim 10, further comprising at least one projection lens disposed such that the microdisplay lies optically between the projection lens and the light source.

13. The projection arrangement of claim 10, wherein the cylindrical optical surface is defined by a cylindrical lens disposed optically between the microdisplay and the light source.

14. The projection arrangement of claim 13 wherein the cylindrical optical surface defines a flat surface opposed to the cylindrical optical surface.

15. The projection arrangement of claim 1, wherein the cylindrical optical surface is disposed approximately half the distance along an optical axis between the microdisplay and the light source.

16. An apparatus comprising:
illumination means comprising a first aspect ratio;
display means comprising a second aspect ratio; and
lens means disposed between the display means and the illumination means, the lens means having an arcuate surface that is shaped for changing an aspect ratio of illumination emanating from the illumination means from the first aspect ratio to the second aspect ratio without clipping the emanating illumination.

17. The apparatus of claim 16, wherein:
the illumination means comprises a light emitting diode chip and the first aspect ratio is 1:1;
the display means comprises a microdisplay having a display surface and the second aspect ratio is other than 1:1, and
the arcuate surface comprises a cylindrical optical surface that defines parallel cross sections, each of which define a center of curvature such that the centers of curvatures together define a line that crosses an optical axis between the microdisplay and the light emitting diode chip or an extension of that optical axis.

18. The apparatus of claim 17, wherein the second aspect ratio is either 4:3 or 16:9.

19. A method for manipulating light comprising:
emanating light from a source having a first aspect ratio;
passing the emanated light through at least one cylindrical optical surface that is shaped to change the emanated light from the first aspect ratio to a second aspect ratio without clipping the emanated light; and thereafter directing the emanated light to a microdisplay surface having the second aspect ratio.

20. The method of claim 19, further comprising directing the light with the second aspect ratio from the microdisplay surface to a projection lens.

21. The method of claim 19, wherein two cylindrical optical surfaces together are shaped to change the emanated light from the first aspect ratio to the second aspect ratio without clipping the emanated light.

22. The method of claim 19, wherein the cylindrical optical surface is disposed approximately half the distance along an optical axis between the source and the microdisplay surface.

23. The method of claim 22, wherein the at least one cylindrical optical surface comprises at least one surface of a lens spaced from the source and from the microdisplay surface.

24. The method of claim 19, wherein emanating light from a source having a first aspect ratio further comprises collecting light from the source and shaping it, in a collection and beam shaping device disposed between the source and the at least one cylindrical optical surface, to an angular substantially rectangular output beam with the first aspect ratio.

25. The method of claim 19, wherein the source, the at least one cylindrical optical surface, and the microdisplay surface are disposed and arranged within a pocket sized device.
